(19) United States
(12) Patent Application Publication
(10) Pub. No.: US 2004/0198315 A1
(43) Pub. Date: Oct. 7, 2004

(54) Travel plan emergency alerting system

(76) Inventor: Jean Paul Vellotti, Stony Brook, NY (US)

Correspondence Address: ST. ONGE STEWARD JOHNSTON & REENS, LLC, 986 BEDFORD STREET, STAMFORD, CT, 06905-5619, US

(21) Appl. No.: 10/817,086

(22) Filed: Apr. 2, 2004

Related U.S. Application Data
(60) Provisional application No. 60/460,170, filed on Apr. 3, 2003.

(51) Int. Cl. G06F 17/60

(52) U.S. Cl. 455/404.1; 705/5

(57) ABSTRACT

A travel plan emergency alerting system is adapted to receive, from a user, user information and trip/alert information (including at least an expected time of return from a trip and contact information for an emergency contact person). The system is adapted to determine, based at least in part upon whether alert deactivation information has been received, whether the user has returned from the trip, and, based at least in part upon the trip/alert information, whether the expected time of return has passed. The system generates and transmits to the emergency contact person an alert message if the expected time of return has passed and if the user has not returned from the trip. In some embodiments, the system also includes a telephone interface through which the alert deactivation information is received. In some embodiments, the trip/alert information and the alert message includes a recorded message in the user's own voice.

### RELATED APPLICATIONS

This patent application claims the benefit of, under Title 35, United States Code, Section 119(e), U.S. Provisional Patent Application No. 60/460,170, filed Apr. 3, 2003.

### FIELD OF THE INVENTION

The present invention relates generally to emergency alerting systems and methods, and more particularly to a system and method for facilitating the locating of persons who become lost or delayed during a scheduled trip, such as in a boat, in a small aircraft, on a bicycle, in an automobile, while camping, while hiking, etc.

### BACKGROUND OF THE INVENTION

One can imagine a day when the weather is beautiful, with not a cloud in the sky, and a boater decides to take a quick ride in his/her boat. This person does not tell anybody about the trip because it will only be a quick ride—a few miles out of the harbor and back. For a great majority of the time, the voyage will indeed be uneventful. But what happens if the boater become disabled at sea and no one is around? At times like these, Murphy's Law often takes over and the bad gets worse. The weather changes, the winds pick up, the battery goes dead on the boat, and the radio and electronics cut out. Adrift, the boater looks for other boaters as he/she head for the rocks. The boater's cell phone doesn't work. Alone, where can the boater turn for help?

This type of situation is commonplace today in the United States. The U.S. Coast Guard recommends that anyone traveling on the water file a float plan, yet because of liability issues and sheer volume, it will not accept float plans from the public. Its recommendation that float plans be filed with family and friends often fails because today's recreational boaters just don't want to fill out an extremely complicated and cumbersome form every time they go boating. Further, when boaters simply say to a friend, “I'm going out,” the responsible party often doesn't know the specifics of the boat, the number of passengers or other vitals that can help the Coast Guard search in case of an emergency.

The present invention is a new solution that bridges technology with personal safety. At the core of the present invention is a service that provides an emergency alerting system based on user input. Developed as a solution for boating safety, the present invention has proven itself useful in other areas where safety is paramount, such as aviation, camping and personal safety, and it should be understood that while the descriptions presented herein often refer to boating and float plans used in conjunction therewith, the present invention may be used in other contexts. As such, in its broadest sense, the present invention may be used by any party taking a “trip” (whether on a boat, in an aircraft, in an automobile, on foot, etc.), in which cases, the person traveling may create a “trip plan” (i.e., a set of data detailing parameters of the trip).

Several websites offer what they call “online float plans.” However, these are generally nothing more than the U.S. Coast Guard float plan which may be filled out, printed, and given to a friend or relative. There is also at least one company (known as BoatFloats.com) that claims to be working on an online float plan solution that will be monitored by humans who will alert the Coast Guard if an emergency develops. Further, there is a company (SailWinds Software, Inc.) which operates a website (http://www.myfloatplans.com) which provides automatic notification to specified contacts if a boater does not de-activate a notification message before a scheduled time.

Moreover, U.S. Patent Application Publication No. US 2002/0066037 A1 discloses an automated system for creating, storing and using registration and itinerary records to provide security to participants. The system claims to automatically monitor itinerary records and prompts the initiation of security response actions such as a telephone call to a participant provided contact person if a participant fails to cancel an itinerary prior to a stated itinerary completion time. The system is also able to receive payment and maintain a current payment status for the participant until a set time of expiration or until the participant fails to cancel an itinerary prior to a stated itinerary completion time.

While such automated or semi-automated systems certainly provide advantages over not preparing any type of trip plan at all, and may provide some advantages over preparing trip plans by hand, they do suffer from a number of disadvantages. One such disadvantage relates to the fact that all known systems rely on the boater's input of data via the Internet to initiate an alert and disable an alert. What if the boater changes his/her mind and stays out longer, but has no Internet access from the boat with which to de-activate the emergency alert? In this case, which happens quite often, a false alert will be sent and a search may be commenced. This is, of course, extremely undesirable.

A further disadvantage is that the information provided to the emergency contact (in those systems where information is so provided), is limited to that information which the systems solicit from the traveling party, whereas the traveling party may wish to supply additional or alternate information. A further disadvantage is that the contact person receiving the emergency message may either not understand the message or not believe its authenticity. It would be far more desirable for at least a portion of the message to be recorded in the traveling party's own voice, with which the contact person is presumably familiar (since the contact person is generally a friend or family member of the traveling party).

What is desired, therefore, is a travel plan emergency alerting system which provides an alert message to a specified emergency contact if a traveling party does not deactivate an alert notification request before a specified return time, which is automatic in nature, which does not require that the traveling party input data via the Internet to initiate an alert and disable an alert, which allows for flexibility in the information the traveling party specifies to be included in any alert notifications, and which provides alert notifications to alerted parties in a manner which is easy to understand and authenticate.

### SUMMARY OF THE INVENTION

Accordingly, it is an object of the present invention to provide a travel plan emergency alerting system which provides an alert message to a specified emergency contact if a traveling party does not deactivate an alert notification request before a specified return time.

Another object of the present invention is to provide a travel plan emergency alerting system having the above characteristics and which is automatic in nature.

A further object of the present invention is to provide a travel plan emergency alerting system having the above characteristics and which does not require that the traveling party input data via the Internet to initiate an alert and disable an alert.

Still another object of the present invention is to provide a travel plan emergency alerting system having the above characteristics and which allows for flexibility in the information the traveling party specifies to be included in any alert notifications.

Yet a further object of the present invention is to provide a travel plan emergency alerting system having the above characteristics and which provides alert notifications to alerted parties in a manner which is easy to understand and authenticate.

These and other objects of the present invention are achieved in one embodiment by provision of a travel plan emergency alerting system having a central computing system adapted to receive, from a user, user information and trip/alert information, the trip/alert information comprising at least an expected time of return from a trip and contact information for an emergency contact person. The system also includes a telephone interface through which the central computing system is adapted to receive alert deactivation information from the user when the user returns from the trip. An alert processing routine executing on the central computing system is adapted to determine, based at least in part upon whether alert deactivation information has been received, whether the user has returned from the trip, and, based at least in part upon the trip/alert information, whether the expected time of return has passed. The alert processing routine generates and transmits to the emergency contact person an alert message if the expected time of return has passed and if the user has not returned from the trip.

In some embodiments, the central computing system is in communication with a computer network, and the central computing system is adapted to receive the trip/alert information via the computer network. In certain of these embodiments, the computer network comprises the Internet. In some embodiments, the central computing system is adapted to receive the trip/alert information via the telephone interface. In some embodiments, the central computing system comprises a telephony server to facilitate input of information by the user.

In some embodiments, the central computing system is adapted to receive from the user modifications to the trip/alert information, including modifications to the expected time of return. In certain of these embodiments, the central computing system is adapted to receive the modifications to the trip/alert information via the telephone interface. In some embodiments, the alert message is transmitted to the emergency contact person as at least one of an email message, a telephone message and a pager message. In some embodiments, the alert message comprises information concerning at least one of a user's boat and equipment thereon, a user's aircraft and equipment thereon, a user's vehicle and equipment therein, a user's camping gear, a time of departure, a planned route of travel, planned stops along the way, and traveling companions.

In some embodiments, the trip/alert information comprises a recorded message in the user's own voice, and the alert message comprises the recorded message in the user's own voice.

In accordance with another embodiment of the present invention, a travel plan emergency alerting system includes a central computing system adapted to receive, from a user, user information and trip/alert information, the trip/alert information comprising at least an expected time of return from a trip, contact information for an emergency contact person and a recorded message in the user's own voice. The central computing system is further adapted to receive alert deactivation information from the user when the user returns from the trip. An alert processing routine executing on the central computing system is adapted to determine, based at least in part upon whether alert deactivation information has been received, whether the user has returned from the trip, and, based at least in part upon the trip/alert information, whether the expected time of return has passed. The alert processing routine generates and transmits to the emergency contact person an alert message if the expected time of return has passed and if the user has not returned from the trip, the alert message comprising the recorded message in the user's own voice.

In some embodiments, the central computing system is in communication with a computer network, and the central computing system is adapted to receive the trip/alert information via the computer network. In certain of these embodiments, the computer network comprises the Internet. In some embodiments, the system further includes a telephone interface, and the central computing system is adapted to receive the trip/alert information via the telephone interface. In some embodiments, the central computing system comprises a telephony server to facilitate input of information by the user.

In some embodiments, the central computing system is adapted to receive from the user modifications to the trip/alert information, including modifications to the expected time of return. In certain of these embodiments, the system further includes a telephone interface, and the central computing system is adapted to receive the modifications to the trip/alert information via the telephone interface. In some embodiments, the alert message is transmitted to the emergency contact person as at least one of an email message, a telephone message and a pager message. In some embodiments, the alert message comprises information concerning at least one of a user's boat and equipment thereon, a user's aircraft and equipment thereon, a users vehicle and equipment therein, a users camping gear, a time of departure, a planned route of travel, planned stops along the way, and traveling companions.

In some embodiments, the system further includes a telephone interface, and the central computing system is adapted to receive the alert deactivation information from the user via the telephone interface.

In accordance with another embodiment of the present invention, a method of generating travel plan emergency alerts comprises the steps of: receiving, from a user, user information and trip/alert information, the trip/alert information comprising at least an expected time of return from a trip and contact information for an emergency contact person; receiving alert deactivation information from the user when the user returns from the trip through a telephone interface; determining, based at least in part upon whether alert deactivation information has been received, whether the user has returned from the trip, and, based at least in part upon the trip/alert information, whether the expected time of return has passed; and generating and transmitting to the emergency contact person an alert message if the expected time of return has passed and if the user has not returned from the trip.

In accordance with another embodiment of the present invention, a method of generating travel plan emergency alerts comprises the steps of: receiving, from a user, user information and trip/alert information, the trip/alert information comprising at least an expected time of return from a trip, contact information for an emergency contact person and a recorded message in the user's own voice; receiving alert deactivation information from the user when the user returns from the trip; determining, based at least in part upon whether alert deactivation information has been received, whether the user has returned from the trip, and, based at least in part upon the trip/alert information, whether the expected time of return has passed; and generating and transmitting to the emergency contact person an alert message if the expected time of return has passed and if the user has not returned from the trip, the alert message comprising the recorded message in the user's own voice.

The invention and its particular features and advantages will become more apparent from the following detailed description considered with reference to the accompanying drawings.

### BRIEF DESCRIPTION OF THE DRAWINGS

FIG. 1 is a schematic view of a travel plan emergency alerting system in accordance with one embodiment of the present invention;

FIG. 2 is a flow chart illustrating operation of the travel plan emergency alerting system shown in FIG. 1; and

FIGS. 3-7 are illustrations showing various screenshots presented to a user of the travel plan emergency alerting system shown in FIG. 1.

### DETAILED DESCRIPTION OF AN EMBODIMENT OF THE INVENTION

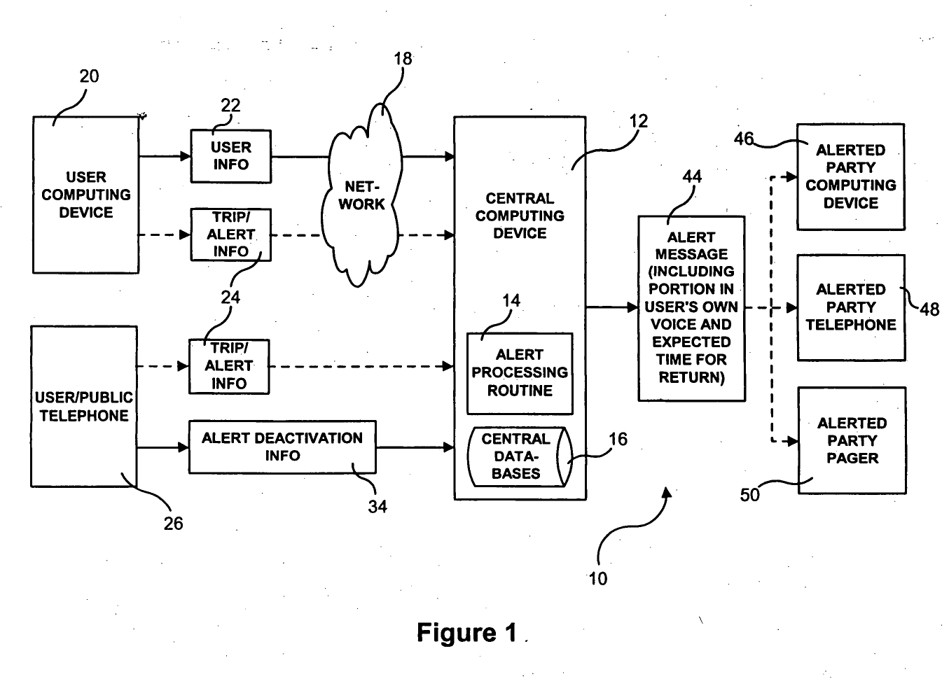

Referring first to FIG. 1, a travel plan emergency alerting system 10 in accordance with the present invention is shown. System 10 includes a central computing device 12, which may comprise for example a server, for managing and maintaining alert processing routine software 14 and central databases 16 for storing the various information discussed below. It should be noted that databases 16 may be located externally from central computing device 12, so long as they are in communication therewith. The central computing device 12 is coupled to a network 18. The network 18 may be any network, for example, the Internet, a satellite communications network, a wireless or wired telecommunications network, a local area network (LAN), a wide area network (WAN), or any combination thereof.

Additionally, at least one (but preferably many) user computing device 20 utilized by the users of system 10 are coupled to the network 18. As is customary, user computing device 20 includes a processor operating software coupled to a memory. The software may include an interface (e.g., a web browser) as understood in the art and facilitate interface and execution with the central computing device 12 for the user to utilize system 10. The processor is further coupled to an I/O unit (e.g., a modem) and a storage device, also as is customary. The storage device may store user databases, where the user databases may include data that is a subset of the central databases 16.

The user computing device 20 further includes input control devices, such as a keyboard and computer mouse, for operating the system 10, and a display for display of information provided by the system 10. While the user computing device 20 may be a desktop computing system, it should be understood that laptop systems, other configured computing systems, or terminals (e.g., interactive televisions) may be utilized. It should also be understood that user computing system 20 may comprise a hand-held computing device, such as a personal digital assistant, a hand-held personal computer, a wireless telephone, or other electronic device capable of communicating with central computing device 12 via network 18.

In operation, the user utilizes user computing system 20 for inputting to central computing device 12 via network 18 user information 22, including general registration information and additional information about the user, the user's boat (or in the case of other applications, aircraft, vehicle, camping gear, etc.), user favorites, etc., as more fully described below.

The user may also employ user computing system 20 for inputting information about the trip the user is planning on taking as well as information pertinent to the alert 24. While trip/alert information 24 may contain a plethora of information, as discussed more fully below, at a minimum it includes an expected return time (i.e., the time when the user expects to return from the trip) as well as contact information (i.e., a telephone number, an email address and/or a pager address) for an emergency contact person. Preferably, trip/alert information 24 also includes a portion thereof which is recorded in the user's own voice, such as a message which the user would like played to the emergency contact as part of any alert message. As indicated by dashed lines in FIG. 1, trip/alert information 24, or portions thereof, may instead of, or in addition to, being input by user employing user computing device 20, be input by the user using a telephone 26 (whether a private telephone owned by the user or another party or a public telephone). This is particularly desirable when the trip/alert information 24 includes a portion thereof which is recorded in the user's own voice.

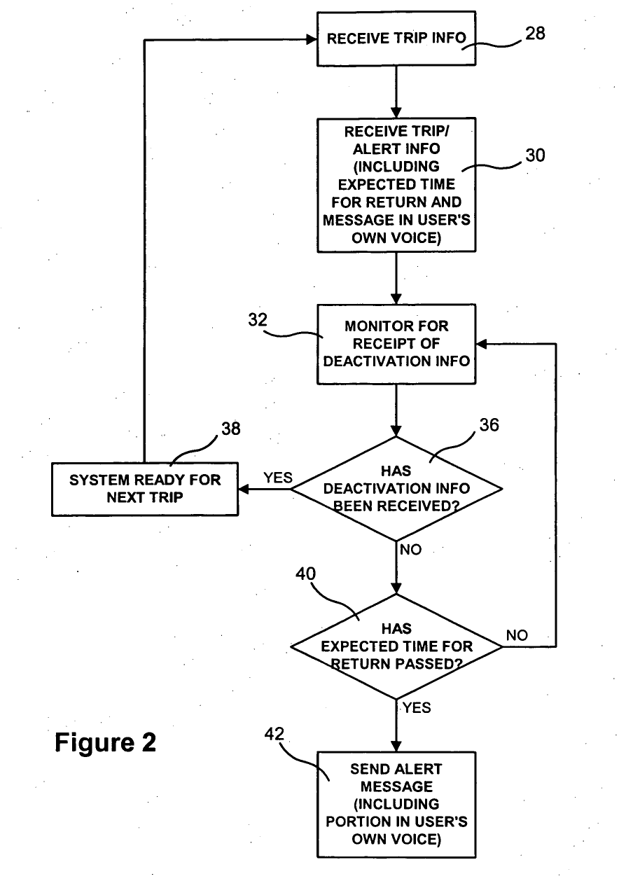

Referring now to FIG. 2 in addition to FIG. 1, alert processing routine 14 receives the trip information at step 28 and the trip alert information 24 at step 30. As discussed above, trip/alert information includes at a minimum an expected return time as well as contact information for an emergency contact person, and preferably a message in the user's own voice. As shown at step 32, once the alert has been activated, system 10 now monitors for receipt of deactivation information 34 (FIG. 1), which would be provided by the user via telephone 26 when the user returns from the trip. It should be noted that instead of deactivation information 34, the user may input modifications to trip/alert information 24, such as for example, if the user decides to extend the trip (i.e., postpone the expected time for return).

If alert deactivation information 34 has been received, a determination is made, at block 36, that system 10 is ready for the next trip (block 38), and operation returns to step 28. If, at block 36, it is determined that no deactivation information has yet been received, system 10 makes a determination (at block 40) as to whether the expected time for return specified by the user has passed. If the expected time for return has not yet passed, system 10 resumes monitoring for alert deactivation information 34 at block 32. However, if at block 40 it is determined that the expected time for return specified by the user has passed, system 10 (as shown at block 42) generates and transmits to the emergency contact person specified by the user an alert message 44.

Alert message 44 may be sent to the alerted party's computing device 46 (for example, if in the form of an email), to the alerted party's telephone 48 and/or to the alerted party's pager 50. Alert message 44 contains information which may be useful in helping to locate the user, such as information concerning the user's boat and equipment thereon (or aircraft, automobile, camping gear, etc. as may be appropriate), information concerning the time of departure, planned route of travel, planned stops along the way, companions, etc. Alert message 44 also contains a recording in the users own voice (if one was provided). If in the form of an email, alert message 44 may include as an attachment a file containing the message in the user's own voice which may be opened and played by the alerted party. If in the form of a page, alert message 44 may include a telephone number which the alerted party may call to hear a recording of the message in the user's own voice.

The present invention is made up of several components. There is an interface available via the Internet (traditional web browser, but also handhelds such as PDAs), and an interface available using the telephone. These two interfaces are generally not identical. The pages delivered over the Internet may be distributed, for example, via Java Server Pages (having a .jsp extension) using a combination of Enterprise Java, 2^{nd} edition (EJ2B) and JavaBeans. Essentially, this language is a heavy-duty version of HTML, which is traditionally a weak programming language. With EJ2B for example, the application can truly be considered “enterprise level” and can support at a minimum of 1 million users and 10,000 concurrent users.

The telephone interface may be driven by VoiceXML, which is an emerging standard for voice applications. The application may also use CallXML (developed by Voxeo Corporation), a language which can be used for free (i.e., is open source), and/or Java 2, Micro Edition (J2ME), a language which is generally used in connection with mobile telephones and other mobile devices.

There are at least two scenarios of how data travels depending on how the user accesses the data, via the phone or the web. First, when a user accesses his/her data over the web, the path of data exchange is as one might expect: HTTP requests are sent over the Internet, a production server receives these requests, processes these requests, and most likely, accesses a database and returns the results via HTTP to the user via his/her web browser. This is often called round trip data exchange using two tiers (a third may be added later). Of course, system 10 may provide industry standard security, including at least 128-bit Secure Socket Layer (SSL).

If a user accesses his/her data over the telephone, an additional component is added: a telephony server. This is basically a computer with special code that interprets the users voice (hence, VoiceXML) and parses his/her data to the central servers.

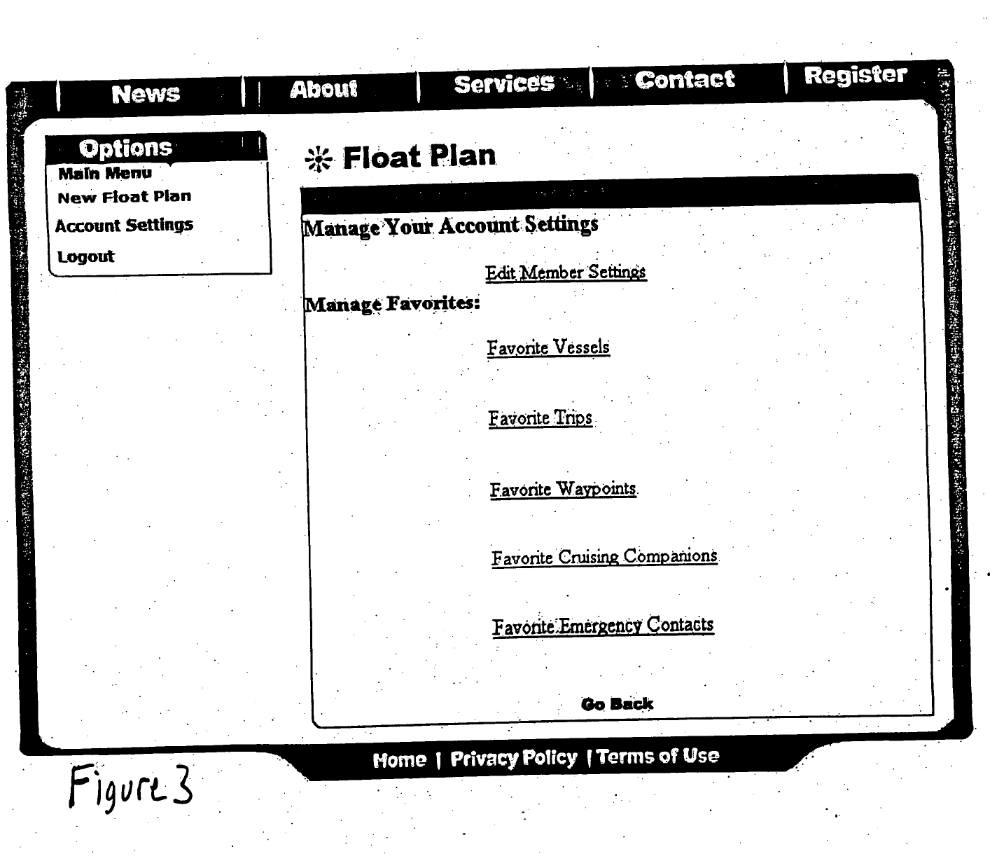

Referring to FIG. 3, using the system of the present invention, a user logs on to the site using the Internet to register for the service, providing basic information like name and address, payment info, details about his/her boat, personal information, contact information, safety equipment onboard, and other pertinent details that would be useful in the event of an emergency. Then the user receives a username/password for the site and a username/password for phone access (the two may be combined so that there is only one username/password given). The user can login and setup preferences for his/her account, referred to as Favorites. These Favorites may be grouped into various categories which will allow quick selection and editing.

Examples of such Favorites may include (in the case of boating):

(a) Favorite vessels—this section stores info about basic vessel details, safety equipment onboard and navigation aids. The user can have more than one vessel in his/her folder.

(b) Favorite Trips—Allows the user to name a trip, plus from where and to where. This is useful for frequent passages, which allows the user to select the trip and fill in the date details.

(c) Favorite Waypoints—Stops along the way of a trip.

(d) Favorite Cruising Companions—Name and details (e.g., age and telephone number) of people that are traveling with the user.

(e) Favorite Emergency Contacts—Name and contact information (e.g., telephone number, email address, pager number, etc.) of a user selected person to contact in case of emergency. The user can also select how the system should contact the user, by phone, email, pager, of combinations thereof.

When a user wants to create a float plan, he/she can either create one on the Internet or using a telephone. An exemplary situation follows: A user arrives at his/her boat, takes the cover off, and warms up the engine. He/she calls an 800 number, enters his/her username/password and selects to create new float plan. Then, selecting from his/her favorites, he/she presses the correct keys on the telephone to select the boat he/she is using today, the trip he/she is going to take, when he/she will leave and arrive, waypoints, passengers aboard, and emergency contacts. Lastly, he/she can record up to 30 seconds of audio of any other pertinent details. This custom message will be in the user's actual voice. In the event of an emergency, this file will be sent with the email, or played back in the case of an automated telephone call. This would be useful to allow the boater to provide very specific details of the trip or information that might not be part of the form system.

By pressing a keypad, his/her plan is activated. If the user plans to travel to somewhere other than a place listed in his/her favorites folder, he/she can create a new favorite trip over the telephone. The same is true for waypoints, persons aboard, and emergency contacts. Using voice recognition, the system stores these entries in a database.

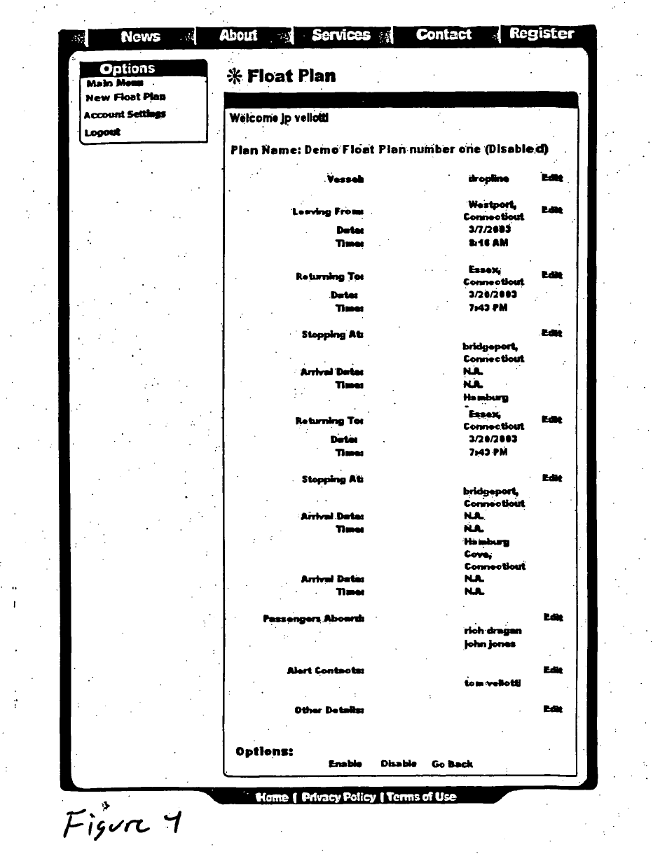

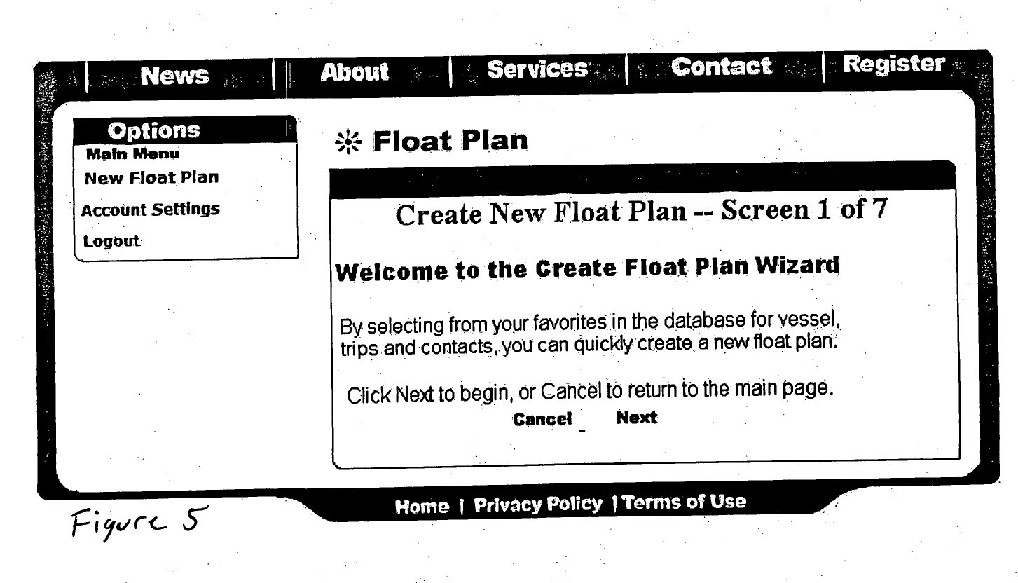

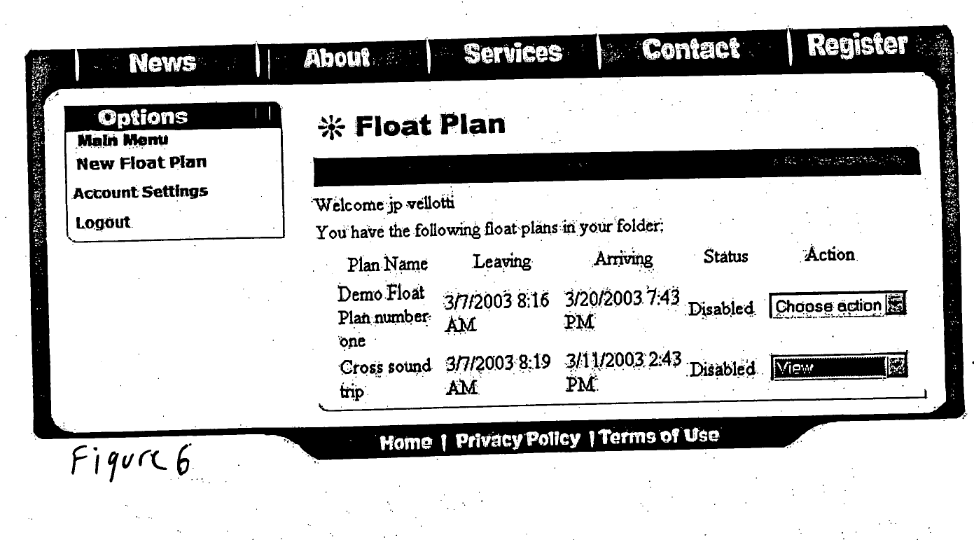

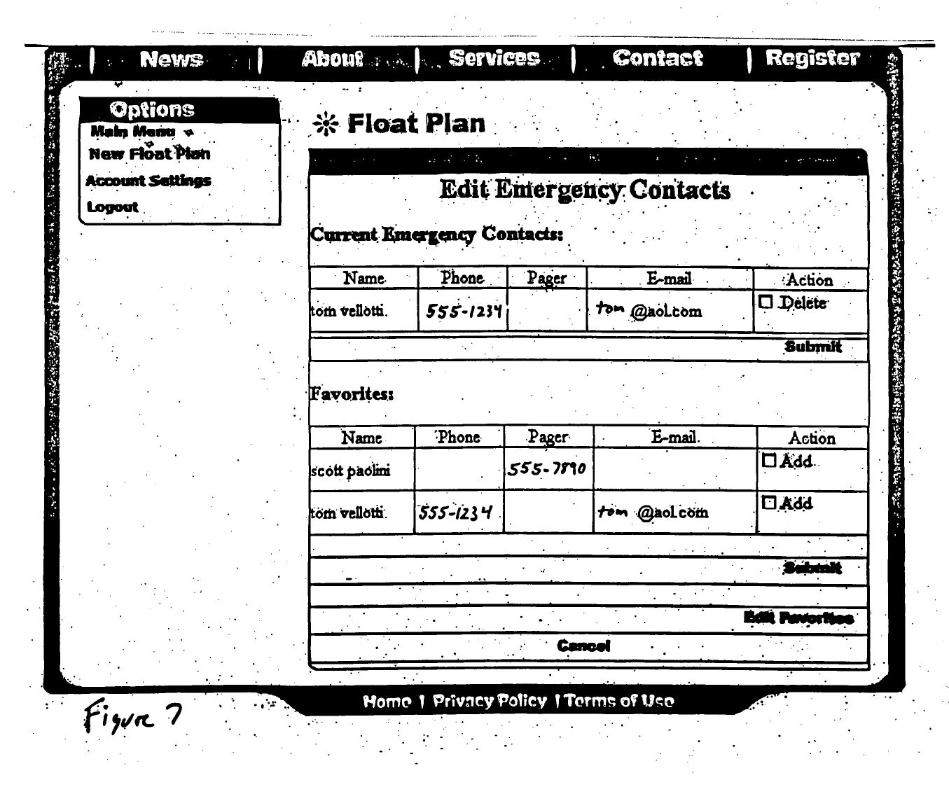

Alternatively, the user can enable a saved plan that he/she created at home using the Internet. A sample screenshot of information entered in a float plan via the Internet is shown in FIG. 4. If desired, a float plan creation wizard may be provided, as shown in the screenshot of FIG. 5. The user may also be able to enable/disable the float plan from the Internet rather than a telephone as shown in FIG. 6. However, it should be recognized that one of the main benefits of the present invention over the prior art is that at least the disablement of a float plan may be accomplished using a telephone rather than the Internet. FIG. 7 shows a screenshot of contact information for an emergency contact person being entered via the Internet.

While the user is cruising, if it becomes apparent that he/she will be late and wishes to extend the alert deadline or wishes to add stops to the voyage, he/she can call back into the system and modify the stored float plan.

Ideally, when the user comes back into port, he/she will call the system to cancel the float plan. However, there is preferably an amount of logic contained in the alert processing routine. Preferably, at some time interval (e.g., 15 minutes) before an alert is overdue, the system will make a call and send an email to the user asking him/her to cancel the plan, if appropriate. If these warnings are ignored, the alerts to selected persons will take place.

Preferably, the system will attempts to send a phone alert, email or page three times before it becomes a failed alert. If the alert goes through, this is recorded in an administration log. If it fails, this is also recorded into the log. Preferably, there are provisions provided for the phone alert to deal with answering machines and answered calls that end prematurely.

Once an alert has been sent to an emergency contact, he/she may wish to hear the message again. Using a touchtone menu, he/she can repeat the message. Also, should the emergency contact wish to call back and hear the message again, he/she will be given a unique code assigned to this particular alert which can be entered into the telephone in order to hear the message again.

When an alert is sent by email, all the data associated with the user is preferably included. This email can then be forwarded to local authorities in the position to help. A hyperlink may included in this email to automatically forward the details to rescue agencies.

To try and prevent false alerts, the system may attempt to authenticate any email or phone number entered. Also, once an emergency contact has been selected, an email may be sent asking for permission to be used as an emergency contact. Preferably, at no time can a user select the emergency number 911 as a contact. A similar logic may apply to police and coast guard numbers, and other numbers on a “blackout list,” like the White House or places of prominent attention.

The system of the present invention has been designed to be fully automated and require little more than one person to make sure the servers are running and code changed as necessary. The system also features a full administration console, which can make running changes and view alerts in progress.

The present invention, therefore, provides a travel plan emergency alerting system which provides an alert message to a specified emergency contact if a traveling party does not deactivate an alert notification request before a specified return time, which is automatic in nature, which does not require that the traveling party input data via the Internet to initiate an alert and disable an alert, which allows for flexibility in the information the traveling party specifies to be included in any alert notifications, and which provides alert notifications to alerted parties in a manner which is easy to understand and authenticate.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A travel plan emergency alerting system comprising:
a central computing system adapted to receive, from a user, user information and trip/alert information, the trip/alert information comprising at least an expected time of return from a trip and contact information for an emergency contact person;
a telephone interface through which said central computing system is adapted to receive alert deactivation information from the user when the user returns from the trip;
an alert processing routine executing on said central computing system, said alert processing routine adapted to determine, based at least in part upon whether alert deactivation information has been received, whether the user has returned from the trip, and, based at least in part upon the trip/alert information, whether the expected time of return has passed; and
said alert processing routine generating and transmitting to the emergency contact person an alert message if the expected time of return has passed and if the user has not returned from the trip.

2. The system of claim 1 wherein said central computing system is in communication with a computer network, and wherein said central computing system is adapted to receive the trip/alert information via the computer network.

3. The system of claim 2 wherein the computer network comprises the Internet.

4. The system of claim 1 wherein said central computing system is adapted to receive the trip/alert information via said telephone interface.

5. The system of claim 1 wherein said central computing system comprises a telephony server to facilitate input of information by the user.

6. The system of claim 1 wherein said central computing system is adapted to receive from the user modifications to the trip/alert information, including modifications to the expected time of return.

7. The system of claim 6 wherein said central computing system is adapted to receive the modifications to the trip/alert information via said telephone interface.

8. The system of claim 1 wherein the alert message is transmitted to the emergency contact person as at least one of an email message, a telephone message and a pager message.

9. The system of claim 1 wherein the alert message comprises information concerning at least one of a users boat and equipment thereon, a user's aircraft and equipment thereon, a user's vehicle and equipment therein, a user's camping gear, a time of departure, a planned route of travel, planned stops along the way, and traveling companions.

10. The system of claim 1 wherein said trip/alert information comprises a recorded message in the user's own voice, and wherein the alert message comprises the recorded message in the user's own voice.

11. A travel plan emergency alerting system comprising:
a central computing system adapted to receive, from a user, user information and trip/alert information, the trip/alert information comprising at least an expected time of return from a trip, contact information for an emergency contact person and a recorded message in the user's own voice;
said central computing system being further adapted to receive alert deactivation information from the user when the user returns from the trip;
an alert processing routine executing on said central computing system, said alert processing routine adapted to determine, based at least in part upon whether alert deactivation information has been received, whether the user has returned from the trip, and, based at least in part upon the trip/alert information, whether the expected time of return has passed; and
said alert processing routine generating and transmitting to the emergency contact person an alert message if the expected time of return has passed and if the user has not returned from the trip, the alert message comprising the recorded message in the user's own voice.

12. The system of claim 11 wherein said central computing system is in communication with a computer network, and wherein said central computing system is adapted to receive the trip/alert information via the computer network.

13. The system of claim 12 wherein the computer network comprises the Internet.

14. The system of claim 11 further comprising a telephone interface, and wherein said central computing system is adapted to receive the trip/alert information via said telephone interface.

15. The system of claim 11 wherein said central computing system comprises a telephony server to facilitate input of information by the user.

16. The system of claim 11 wherein said central computing system is adapted to receive from the user modifications to the trip/alert information, including modifications to the expected time of return.

17. The system of claim 16 further comprising a telephone interface, and wherein said central computing system is adapted to receive the modifications to the trip/alert information via said telephone interface.

18. The system of claim 11 wherein the alert message is transmitted to the emergency contact person as at least one of an email message, a telephone message and a pager message.

19. The system of claim 11 wherein the alert message comprises information concerning at least one of a user's boat and equipment thereon, a users aircraft and equipment thereon, a users vehicle and equipment therein, a user's camping gear, a time of departure, a planned route of travel, planned stops along the way, and traveling companions.

20. The system of claim 11 further comprising a telephone interface, and wherein said central computing system is adapted to receive the alert deactivation information from the user via said telephone interface.

21. A method of generating travel plan emergency alerts comprising the steps of:
receiving, from a user, user information and trip/alert information, the trip/alert information comprising at least an expected time of return from a trip and contact information for an emergency contact person;
receiving alert deactivation information from the user when the user returns from the trip through a telephone interface;
determining, based at least in part upon whether alert deactivation information has been received, whether the user has returned from the trip, and, based at least in part upon the trip/alert information, whether the expected time of return has passed; and
generating and transmitting to the emergency contact person an alert message if the expected time of return has passed and if the user has not returned from the trip.

22. A method of generating travel plan emergency alerts comprising the steps of:
receiving, from a user, user information and trip/alert information, the trip/alert information comprising at least an expected time of return from a trip, contact information for an emergency contact person and a recorded message in the user's own voice;
receiving alert deactivation information from the user when the user returns from the trip;
determining, based at least in part upon whether alert deactivation information has been received, whether the user has returned from the trip, and, based at least in part upon the trip/alert information, whether the expected time of return has passed; and
generating and transmitting to the emergency contact person an alert message if the expected time of return has passed and if the user has not returned from the trip, the alert message comprising the recorded message in the user's own voice.
